(19) United States
(12) Patent Application Publication
(10) Pub. No.: US 2024/0161747 A1
(43) Pub. Date: May 16, 2024

(54) ELECTRONIC DEVICE INCLUDING TEXT TO SPEECH MODEL AND METHOD FOR CONTROLLING THE SAME

(71) Applicants: Samsung Electronics Co., Ltd., Suwon-si (KR); Korea Advanced Institute of Science and Technology, Daejeon (KR)

(72) Inventors: Junesig Sung, Suwon-si (KR); Seongyeop Jeong, Daejeon (KR); Jaesik Choi, Daejeon (KR)

(73) Assignees: Samsung Electronics Co., Ltd., Suwon-si (KR); Korea Advanced Institute of Science and Technology, Daejeon (KR)

(21) Appl. No.: 18/511,369

(22) Filed: Nov. 16, 2023

Related U.S. Application Data
(63) Continuation of application No. PCT/KR2023/018345, filed on Nov. 15, 2023.

(30) Foreign Application Priority Data
Nov. 16, 2022 (KR) 10-2022-0153726
Jan. 6, 2023 (KR) 10-2023-0002473

(51) Int. Cl. G10L 15/22; G10L 15/06

(52) U.S. Cl. CPC G10L 15/22; G10L 15/063

(57) ABSTRACT

Provided is an electronic device and method of controlling same, the electronic device including: memory; and at least one processor operatively connected with the memory, wherein the at least one processor is configured to: obtain a voice signal based on a text to speech (TTS) model including a plurality of nodes, stored in the memory, wherein the voice signal corresponds to an input text, based on identifying that the voice signal includes an error, identify an error part of the voice signal which includes the identified error, identify an activity of each of the plurality of nodes related to the error part, and modify at least one node among the plurality of nodes based on the identified activity of the at least one node.

### CROSS-REFERENCE TO RELATED APPLICATIONS

This application is a by-pass continuation of an International application No. PCT/KR2023/018345, filed on Nov. 15, 2023, which is based on and claims priority to Korean Patent Application No. 10-2022-0153726, filed on Nov. 16, 2022, in the Korean Intellectual Property Office, and Korean Patent Application No. 10-2023-0002473, filed on Jan. 6, 2023, in the Korean Intellectual Property Office, the disclosures of which are incorporated by reference herein in their entirety.

### BACKGROUND

### 1. Field

The disclosure relates to an electronic device including a text to speech (TTS) model and a control method thereof.

### 2. Description of Related Art

Various services and additional functions provided through electronic devices, for example portable electronic devices such as smartphones, are gradually increasing. In order to increase the utility value of these electronic devices and satisfy the needs of various users, communication service providers or electronic device manufacturers are competitively developing electronic devices to provide various functions and to differentiate themselves from other companies. Accordingly, various functions provided through electronic devices are also becoming increasingly sophisticated.

Recently, various services using artificial intelligence agents (e.g., Bixby™ Assistant™, Alexa™, etc.) providing responses to user voice inputs are being provided. In particular, natural synthesized sounds may be output by integrally modeling the relationship between input text and sound characteristics through text to speech (TTS) technology.

### SUMMARY

According to an embodiment, an electronic device may comprise at least one memory and at least one processor operatively connected with the at least one memory.

According to an embodiment, wherein the at least one memory may store instructions configured to, when executed by the at least one processor, cause the electronic device to, obtain a voice signal based on a text to speech (TTS) model including a plurality of nodes, stored in the at least one memory, wherein the voice signal corresponds to an input text.

According to an embodiment, wherein the at least one memory may store instructions configured to, when executed by the at least one processor, cause the electronic device to, based on identifying that the voice signal includes an error, identify an error part of the voice signal which includes the identified error.

According to an embodiment, wherein the at least one memory may store instructions configured to, when executed by the at least one processor, cause the electronic device to, identify an activity of each of the plurality of nodes related to the error part.

According to an embodiment, wherein the at least one memory may store instructions configured to, when executed by the at least one processor, cause the electronic device to, modify at least one node among the plurality of nodes based on the identified activity of the at least one node.

According to an embodiment, wherein the at least one memory may store instructions configured to, when executed by the at least one processor, cause the electronic device to, when executed by the at least one processor, cause the electronic device to reduce a weight related to the at least one node.

According to an embodiment, wherein the at least one memory may store instructions configured to, when executed by the at least one processor, cause the electronic device to, when executed by the at least one processor, cause the electronic device to replace the at least one node with at least one pre-stored node.

According to an embodiment, wherein the at least one pre-stored node is stored in the at least one memory and corresponds to text corresponding to the error part.

According to an embodiment, wherein the at least one memory may store instructions configured to, when executed by the at least one processor, cause the electronic device to, based on identifying that the voice signal includes at least one phoneme having a length equal to or greater than a preset length, identify a part of the voice signal corresponding to the at least one phoneme as the error part.

According to an embodiment, wherein the at least one memory may store instructions configured to, when executed by the at least one processor, cause the electronic device to, based identifying that the voice signal includes a waveform part having an abnormal waveform, identify the waveform part as the error part.

According to an embodiment, wherein an automatic speech recognition (ASR) model is stored in the at least one memory.

According to an embodiment, wherein the at least one memory may store instructions configured to, when executed by the at least one processor, cause the electronic device to, obtain text which is a result of applying the ASR model to the voice signal.

According to an embodiment, wherein the at least one memory may store instructions configured to, when executed by the at least one processor, cause the electronic device to, based on identifying that the text includes a part which is different from the input text, identify the part which is different from the input text as the error part.

According to an embodiment, wherein the electronic device further comprises a display.

According to an embodiment, wherein the at least one memory may store instructions configured to, when executed by the at least one processor, cause the electronic device to, display the input text on the display.

According to an embodiment, wherein the at least one memory may store instructions configured to, when executed by the at least one processor, cause the electronic device to, identify the error part based on a user input received through the display, wherein the user input comprises selection of a portion of the input text.

According to an embodiment, wherein the at least one memory may store instructions configured to, when executed by the at least one processor, cause the electronic device to, identify a sentence structure of the input text.

According to an embodiment, wherein the at least one memory may store instructions configured to, when executed by the at least one processor, cause the electronic device to, obtain, based on the sentence structure, at least one character string.

According to an embodiment, wherein the at least one memory may store instructions configured to, when executed by the at least one processor, cause the electronic device to, obtain a character string voice signal resulting from inputting the at least one character string into the TTS model.

According to an embodiment, wherein the at least one memory may store instructions configured to, when executed by the at least one processor, cause the electronic device to, identify, based on the character string voice signal, whether the error part has been modified.

According to an embodiment, wherein the at least one character string is obtained by changing a text before or after a portion of the input text corresponding to the error part.

According to an embodiment, wherein the electronic device further comprises a communication module.

According to an embodiment, wherein the at least one memory may store instructions configured to, when executed by the at least one processor, cause the electronic device to, control the communication module to transmit to a server information related to the error part and the modification of the at least one node.

According to an embodiment, wherein the at least one memory may store instructions configured to, when executed by the at least one processor, cause the electronic device to, receive, through the communication module, a modified TTS model from the server.

According to an embodiment, wherein the at least one memory may store instructions configured to, when executed by the at least one processor, cause the electronic device to, update the TTS model stored in the at least one memory based on the modified TTS model.

According to an embodiment, a method of controlling an electronic device, the method may comprise, obtaining a voice signal based on a text to speech (TTS) model, including a plurality of nodes, stored in at least one memory of the electronic device, wherein the voice signal corresponds to an input text.

According to an embodiment, the method may comprise, based on identifying that the voice signal includes an error, identifying an error part of the voice signal which includes the identified error.

According to an embodiment, the method may comprise, identifying an activity of each of the plurality of nodes related to the error part.

According to an embodiment, the method may comprise, modifying at least one node among the plurality of nodes based on the identified activity of the at least one node.

According to an embodiment, wherein the modifying the at least one node comprises reducing a weight related to the at least one node.

According to an embodiment, wherein the modifying the at least one node comprises replacing the at least one node with at least one pre-stored node corresponding to text corresponding to the error part.

According to an embodiment, wherein the identifying the error part may comprise, based on identifying that the voice signal includes at least one phoneme having a length equal to or greater than a preset length, identifying a part of the voice signal corresponding to the at least one phoneme as the error part.

According to an embodiment, wherein the identifying the error part may comprise, based on identifying that the voice signal includes a waveform part having an abnormal waveform, identifying the waveform part as the error part.

According to an embodiment, wherein an automatic speech recognition (ASR) model may be stored in the at least one memory.

According to an embodiment, wherein the identifying the error part may comprise, obtaining text which is a result of applying the ASR model to the voice signal.

According to an embodiment, wherein the identifying the error part may comprise, based on identifying that the text includes a part which is different from the input text, identifying the part which is different from the input text as the error part.

According to an embodiment, wherein the identifying the error part may comprise, displaying the input text on a display of the electronic device.

According to an embodiment, wherein the identifying the error part may comprise, identifying the error part based on a user input received through the display, wherein the user input comprises selection of a portion of the input text.

According to an embodiment, the method may further comprise, identifying a sentence structure of the input text.

According to an embodiment, the method may further comprise, obtaining, based on the sentence structure, at least one character string.

According to an embodiment, the method may further comprise, obtaining a character string voice signal resulting from inputting the at least one character string into the TTS model.

According to an embodiment, the method may further comprise, identifying, based on the character string voice signal, whether the error part has been modified.

According to an embodiment, the method may further comprise, wherein the obtaining at least one character string comprises changing a text before or after a portion of the input text corresponding to the error part.

According to an embodiment, the method may further comprise, transmitting to a server information related to the error part and the modification of the at least one node.

According to an embodiment, the method may further comprise, receiving a modified TTS model from the server.

According to an embodiment, the method may further comprise, updating the TTS model stored in the at least one memory based on the modified TTS model.

According to an embodiment, a non-transitory computer readable medium storing one or more programs, the one or more programs may comprise instructions that enable an electronic device to, obtain a voice signal based on a text to speech (TTS) model, including a plurality of nodes, stored in at least one memory of the electronic device, wherein the voice signal corresponds to an input text.

According to an embodiment, wherein the one or more programs may comprise instructions that enable an electronic device to, based on identifying that the voice signal includes an error, identify an error part of the voice signal which includes the identified error.

According to an embodiment, wherein the one or more programs may comprise instructions that enable an electronic device to, identify an activity of each of the plurality of nodes related to the error part.

According to an embodiment, wherein the one or more programs may comprise instructions that enable an electronic device to, reduce a weight related to at least one node among the plurality of nodes based on the identified activity of the at least one node.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to an embodiment;

FIG. 2 is a flowchart illustrating a modification operation of a TTS model of an electronic device according to an embodiment;

FIG. 3 is a diagram illustrating a modification operation of a TTS model of an electronic device according to an embodiment;

FIG. 4A is a diagram illustrating an operation of identifying an error part of a voice signal of an electronic device according to an embodiment;

FIG. 4B is a diagram illustrating an operation of modifying at least one node of a TTS model of an electronic device according to an embodiment;

FIG. 4C is a diagram illustrating a voice signal in which an error part is modified through a modified TTS model of an electronic device according to an embodiment;

FIG. 5 is a diagram illustrating an operation of identifying an error part of a voice signal of an electronic device by a user input according to an embodiment;

FIG. 6 is a diagram illustrating an operation of modifying an error part by a user input of an electronic device according to an embodiment;

FIG. 7 is a diagram illustrating an operation of updating a TTS model, based on error information collected from various users of an electronic device according to an embodiment;

FIG. 8 is a diagram illustrating an error report displayed on an electronic device according to an embodiment; and

FIG. 9 is a diagram illustrating a user interface that may be viewed by an administrator of a TTS model according to an embodiment.

### DETAILED DESCRIPTION

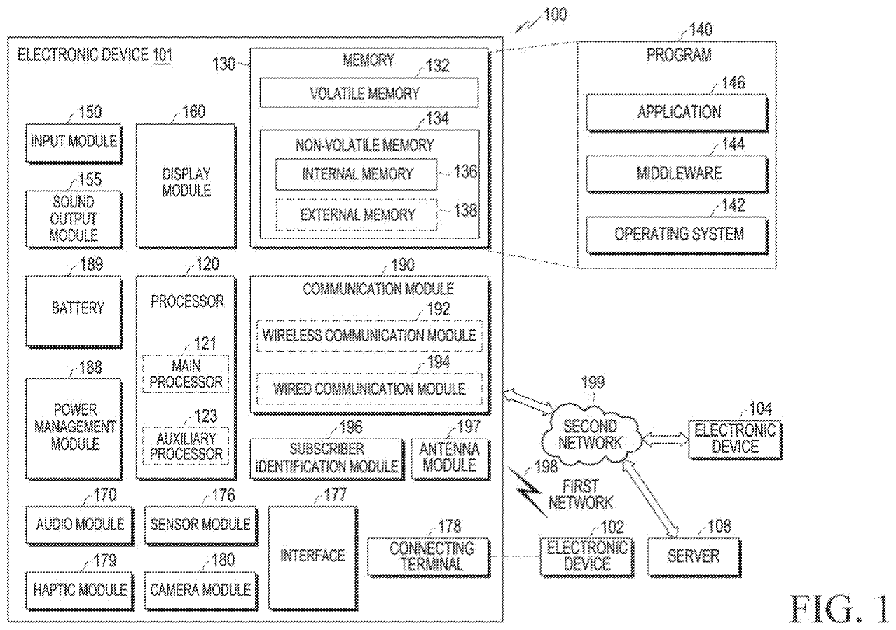

FIG. 1 is a block diagram illustrating an electronic device 101 in a network environment 100 according to one or more embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiments, at least one of the components (e.g., the connecting terminal 178) may be omitted from the electronic device 101, or one or more other components may be added in the electronic device 101. In one or more embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

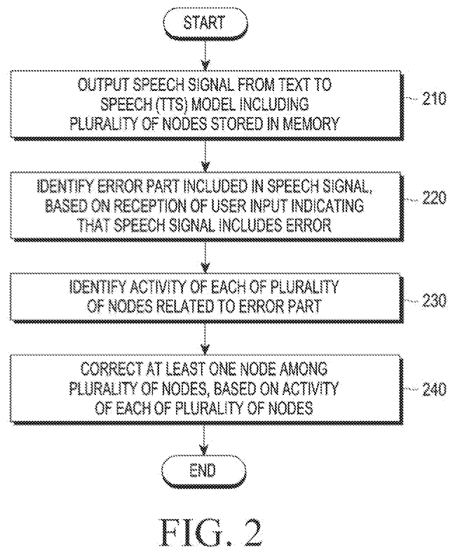

FIG. 2 is a flowchart illustrating a modification operation of a TTS model of an electronic device according to an embodiment.

Referring to FIG. 2, in operation 210, the electronic device (e.g., the electronic device 101 of FIG. 1 or the processor 120 of FIG. 1) may output a voice signal, based on a text to speech (TTS) model including a plurality of nodes stored in a memory (e.g., the memory 130 of FIG. 1). According to an embodiment, the voice signal may be output to the outside of the electronic device through a speaker (e.g., the audio output module 155 of FIG. 1).

TTS is a technology that converts text-type information into voice-type information. According to an embodiment, the TTS may generate the most appropriate voice when an arbitrary text is given by learning a data pair consisting of {text, sound source}. The text is converted into a pronunciation string that may cover all the utterance characteristics of each language, and the electronic device obtains the most similar feature from a given pronunciation string from an acoustic model and converts the same into a sound source (or a voice signal).

According to an embodiment, the acoustic model may generally be made from one of a unit selection method, a statistics-based method, and a deep learning method. For example, the unit selection method is a technology of structuring and holding actual voice fragments, selecting a voice fragment most suitable for a requested pronunciation string, and then concatenating the voice fragments to generate a sound source.

According to an embodiment, the statistics-based method is a technology of extracting feature parameters from voice data, clustering them to form representative parameters of each pronunciation string, and generating sound sources by utilizing a mathematical source-filter model.

According to an embodiment, the deep learning method may be a technology of replacing parts constituting representative parameters of each pronunciation string and source-filter models in the statistical-based method with the deep learning model.

The deep learning method may generate a synthesized sound, based on a neural net model including a large amount of model parameters (e.g., weight, activation function information, model structure, etc.), and contain and express a large amount of information from the relationship between the degree of freedom and weight of each model parameter. Model parameters may be configured in a hierarchical form, such as a layer, and one model may include tens to hundreds of layers. The number of model parameters ranges from hundreds of thousands to billions, and in general, models in the field of speech synthesis/generation may include millions to tens of millions of model parameters. There is also a method of learning the relationship between sound source samples from text, and there is also a method of first generating a voice parameter sequence from text, and then generating a sound source sample from the voice parameter sequence.

According to an embodiment, in operation 220, the electronic device may identify an error part included in the speech signal, based on identification that the voice signal includes an error.

According to an embodiment, the electronic device may identify the error part included in the voice signal, based on the reception of a user input indicating that the output voice signal includes an error.

According to an embodiment, the electronic device may identify a part corresponding to at least one phoneme as an error part, based on the inclusion of at least one phoneme having a preset length or more among a plurality of phonemes included in the voice signal. For example, when the same phoneme is duplicated several times, it is likely to be an error, so the electronic device may identify the part corresponding to the phoneme having a preset length or more as the error part. For example, when the maximum length of the /a/ pronunciation is specified as 200 ms, and /a/ with a length exceeding 200 ms exists in the generated sentence, the electronic device may determine that an utterance error has occurred. According to an embodiment, whether each pronunciation corresponds to the maximum length for determining utterance errors may also be determined by an intermediate stage result (e.g., pronunciation string) before the sound source is generated, and in this case, it is possible to identify an error part by converting a length value at a frame level, which is an intermediate stage of generating a sound source.

According to an embodiment, based on the included waveform part having a value outside the preset range (e.g., abnormal waveform) among the waveforms of the voice signal, the electronic device may identify the waveform part as the error part. According to an embodiment, even in sentences composed of the same letter, the expression characteristics of voice appear slightly different depending on spacing, and when the output made from a specific phoneme string has a significant difference in waveform compared to other phoneme strings, the electronic device may identify it as an error part.

For example, when a user identifies that an error has occurred in the “the room” part of the sound source “Daddy enters the room”, the electronic device may generate normal sentences such as “Daddyen ters the room” and/or “Daddy enters the room”, or generate similar phoneme sequences, such as “Da ddyen ters the room” and/or “Dad dy en ters the room’. The feeling may be subtly different for each sentence, but the difference is not large in terms of the difference in the spectral waveform (e.g., distance). However, if noise appears at the location “the room”, this part will have a large difference in spectral waveform when compared with the voice signal corresponding to the other phoneme string, and the electronic device may identify this part as an error part.

According to an embodiment, the memory may include an automatic speech recognition (ASR) model. According to an embodiment, at least one processor may obtain text which is a result of recognition of the voice signal by using the ASR model, and identify the other part as an error part, based on the inclusion of the text having a part different from the input text corresponding to the voice signal input to the TTS model.

The automatic speech recognition model of an embodiment may convert voice input into text data.

According to an embodiment, in the case of speech recognition, because the result tends to vary depending on the language model, the electronic device may more accurately identify the error part, based on the speech recognition result for the output speech.

According to an embodiment, the electronic device may identify the error part through user input. According to an embodiment, the electronic device may display input text corresponding to a voice signal input to the TTS model on a display and receive a user input for selecting an error part of the input text through the display.

According to an embodiment, the electronic device may identify a voice part corresponding to an error part of input text selected by a user input as an error part of the voice signal. According to an embodiment, an operation of specifying the error part by the user input will be described with reference to FIGS. 6 and 8.

According to an embodiment, in operation 230, the electronic device may identify the activity of each of a plurality of nodes related to the error part.

According to an embodiment, the electronic device may identify the activity (or contribution) of a plurality of nodes included in the TTS model through layer-wise relevance propagation (LRP) technology.

According to an embodiment, the contribution to the output of each of a plurality of nodes included in the TTS model may be quantified in units of nodes, based on the weight and the node activity.

According to an embodiment, LRP technology may be referred to as a technology for analyzing the operating principle of a model, an XAI (eXplainable AI) technology, or a technology for quantifying contribution to an output.

According to an embodiment, in operation 240, the electronic device may modify at least one node among a plurality of nodes, based on the activity of each of the plurality of nodes.

According to an embodiment, the electronic device may obtain activity of each of a plurality of nodes for the error part and modify at least one node having a high contribution to the error part. According to an embodiment, the electronic device may reduce a weight related to at least one node having a high contribution to the error part.

According to an embodiment, the electronic device may modify the weight of at least one node having a high contribution to the error part to 0.

According to an embodiment, the electronic device may replace at least one node with pre-stored at least one node related to text corresponding to the error part. For example, when “room” is identified as an error in the input text “Daddy enters the room”, at least one node (or algorithm) that has been verified by changing the “room” to a normal voice may be replaced with at least one node related to the error part.

According to an embodiment, the electronic device may verify the modified TTS model through a character string similar to the input text. A synthesized sound may be generated by using a character string obtained through one or more embodiments disclosed below and a modified TTS model, and an error may be determined from the synthesized sound. If there is no error, the modified TTS model may be used for speech synthesis later. If there is an error, additional modifications like operation 230, for example, may be performed.

According to an embodiment, the electronic device may identify the sentence structure of the input text corresponding to the voice signal input to the TTS model and obtain at least one character string, based on the sentence structure. According to an embodiment, when the input text has a descriptive sentence structure, the electronic device may obtain at least one descriptive character string. According to an embodiment, when a noun is disposed at the ending word of the input text, such as a news headline, the electronic device may obtain at least one character string in which the noun is disposed at the ending word.

According to an embodiment, at least one character string may be a text obtained by changing the text before and/or after the error part of the input text corresponding to the voice signal input to the TTS model. For example, the electronic device may obtain at least one character string similar to the input text by maintaining a word including an error-occurred character string and modifying words before and after the word with other similar words.

According to an embodiment, when an error occurs in a specific phoneme in a character string, the electronic device may obtain at least one character string in which the specific phoneme with the error is changed to another phoneme.

According to an embodiment, the electronic device may obtain at least one character string including the same letter and/or word as the error part among a plurality of pre-stored character strings.

According to an embodiment, the electronic device may obtain at least one character string by inserting a word in which an error occurs into a pre-stored sentence template. The electronic device may input at least one obtained character string into the TTS model, and determine whether to modify an error part, based on a voice signal for the at least one character string output based on the TTS model.

According to an embodiment, the electronic device may use modification information of a TTS model modified by another electronic device (e.g., the electronic device 104 of FIG. 1) and/or a user through a server (e.g., the server 108 of FIG. 1) to update the TTS model stored in the electronic device.

For example, the electronic device may transmit information related to the error part and the modification of at least one node to the server, receive a modified TTS model from the server, and update the TTS model stored in the memory, based on the modified TTS model.

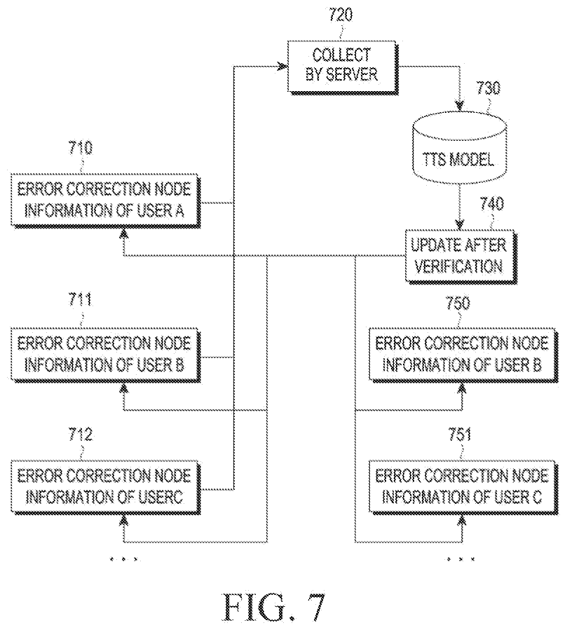

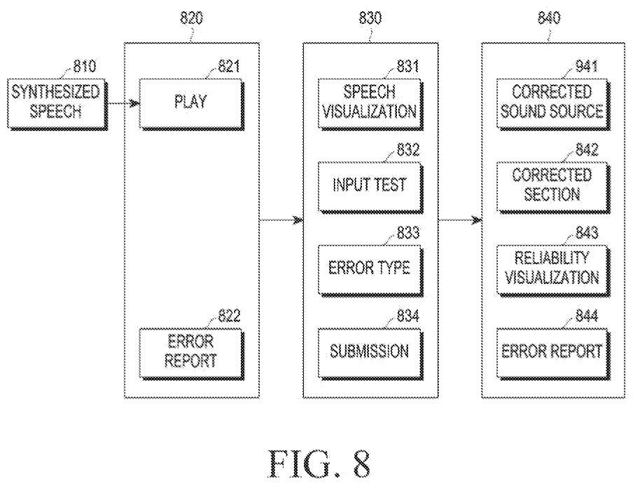

According to an embodiment, an operation of an electronic device using modification information of a TTS model modified by another electronic device and/or a user will be described with reference to FIG. 7.

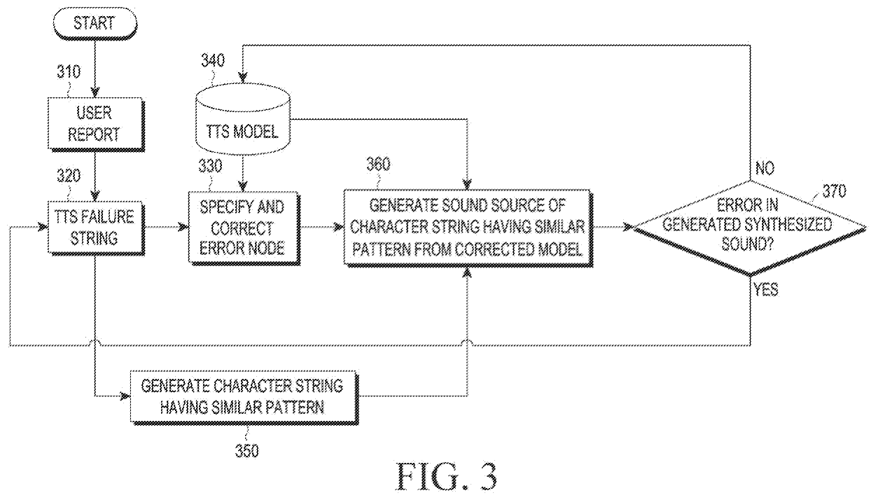

FIG. 3 is a diagram illustrating a modification operation of a TTS model of an electronic device according to an embodiment.

According to an embodiment, the electronic device (e.g., the electronic device 101 of FIG. 1 or the processor 120 of FIG. 1) may obtain a user report in operation 310. According to an embodiment, the electronic device may output a voice signal obtained through the TTS model and receive a user input (e.g., a user report) notifying that there is an error in the voice signal.

According to an embodiment, in operation 320, the electronic device may obtain a TTS failure string.

According to an embodiment, as in operation 220 of FIG. 2, the electronic device may obtain at least one phoneme part of a length greater than or equal to a preset length in the voice signal, a part of the waveform outside the preset range, a part in which the recognized text and the input text are different when the voice signal is automatically recognized, and/or a part selected as an error by a user input, as the TTS failure string.

According to an embodiment, in operation 330, the electronic device may specify and modify the error node.

According to an embodiment, the electronic device may identify at least one node related to the error part among the plurality of nodes of the TTS model 340 through LRP technology, as illustrated in operation 230 of FIG. 2.

According to an embodiment, as in operation 240 of FIG. 2, the electronic device may modify the at least one node by reducing the weight of the at least one identified node, modifying the at least one node to 0, or replacing the algorithm with another reliable algorithm.

According to an embodiment, the TTS model may cause an utterance error in a similar pattern when an utterance error occurs in a character string of a specific pattern. For example, a TTS model trained with data where all sentences end in descriptive sentences is highly likely to generate an utterance error when nouns, such as a news headlines, are located at the end of sentences.

Accordingly, an operation of verifying a modified TTS model through a string similar to a TTS failure string will be described below in order to improve the stability of the TTS model.

According to an embodiment, in operation 350, the electronic device may generate a character string having a similar pattern.

According to an embodiment, the electronic device may generate character strings similar to the error string to verify the modified TTS model.

For example, if an utterance error occurred in the /room/ part of the input text “Daddy enters the room”, and at least one node of the TTS model related to the error was modified, the electronic device may maintain /room/, and changes letters/words adjacent to /room/ to other letters/words to identify whether /room/ is uttered normally.

For example, the electronic device may generate similar character strings such as “Daddy enters the room”, “Daddy enters his room” and/or “Daddy enters the room as well”. According to an embodiment, the electronic device may generate many similar character strings in addition to the above-described examples.

For example, if it is identified that an error occurs in a specific phoneme of the input text, the electronic device may obtain a similar character string obtained by changing the corresponding phoneme to another phoneme. According to an embodiment, the electronic device may obtain a sentence including a word among several pre-stored sentences as a similar character string. According to an embodiment, the electronic device may generate a similar character string by inserting an error-occurred word into a pre-stored sentence template.

According to an embodiment, in operation 360, the electronic device may generate a sound source of a character string having a similar pattern, based on the modified model.

According to an embodiment, the electronic device may obtain at least one voice signal respectively corresponding to the at least one similar character string by inputting the generated at least one similar character string to the modified TTS model.

According to an embodiment, in operation 370, the electronic device may identify whether the generated synthesized sound has an error.

According to an embodiment, the electronic device may identify whether the error parts, such as at least one phoneme part of a length greater than or equal to a preset length in the voice signal respectively corresponding to at least one similar character string, a part of the waveform outside the preset range, a part in which the recognized text and the input text are different when the voice signal is automatically recognized, and/or a part selected as an error by a user input, are included.

According to an embodiment, if there is no error in the generated synthesized sound (370—No), the electronic device may reflect the modified node to the TTS model 340.

According to an embodiment, if there is an error in the generated synthesized sound (370—Yes), the electronic device may return to operation 320 to identify the error part again and repeat the modification.

In this way, if the TTS model is modified for a specific error, it is possible to improve model stability by checking utterances with a similar pattern and identifying that the modification is universally applicable to character strings with a similar pattern.

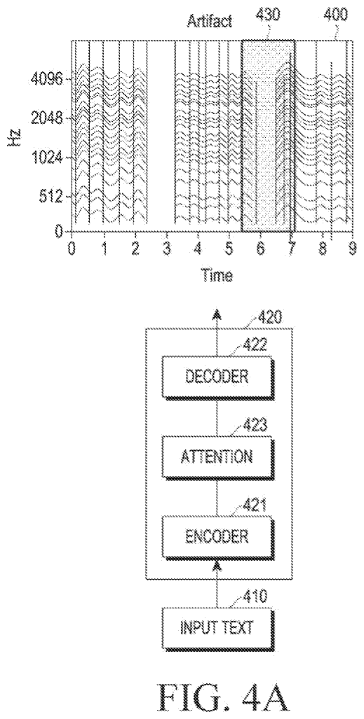

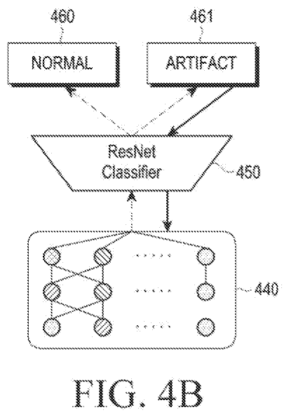

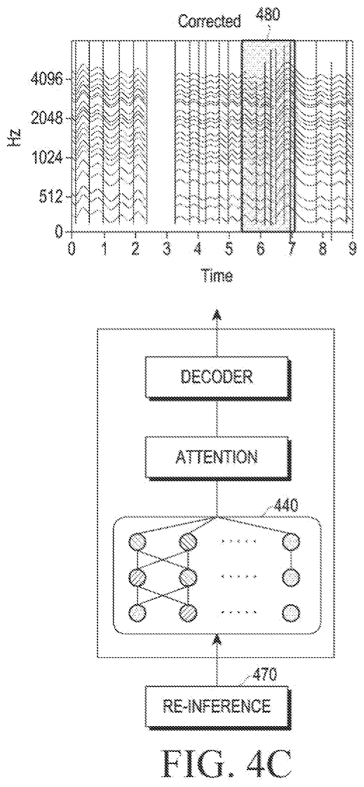

FIG. 4A is a diagram illustrating an operation of identifying an error part of a voice signal of an electronic device according to an embodiment.

Referring to FIG. 4A, an electronic device (e.g., the electronic device 101 of FIG. 1 or the processor 120 of FIG. 1) may obtain a voice signal by using input text 410 and a TTS model 420.

According to an embodiment, the TTS model 420 may obtain a voice signal 400 through an encoder 421 related to utterance and a decoder 422 related to timbre. For example, the TTS model 420 may be based on a sequence-to-sequence model. For example, the TTS model 420 may include the encoder 421, the decoder 422, and/or attention 423. The attention 423 is context information used to determine the current output value in the decoder 422, and may be understood as weights for a weighted sum of all hidden state vectors generated by the encoder 421.

According to an embodiment, the electronic device may identify an artifact 430 included in the voice signal output from the TTS model 420. For example, as in operation 220 of FIG. 2, the electronic device may obtain at least one phoneme part of a length greater than or equal to a preset length in the voice signal, a part of the waveform outside the preset range, a part in which the recognized text and the input text are different when the voice signal is automatically recognized, and/or a part selected as an error by a user input, as the artifact 430.

FIG. 4B is a diagram illustrating an operation of modifying at least one node of a TTS model of an electronic device according to an embodiment. In FIG. 4B, the path marked by the dotted line may refer to a path for utilization (or inference) of the model, and the path marked by the solid line may refer to a path for propagation (e.g., it may be layer-wise relevance propagation (LRP), but is not limited thereto).

Referring to FIG. 4B, the electronic device may measure the degree to which each node in the encoder 440 (e.g., the encoder 421 of the TTS model of FIG. 4A) of the TTS model has contributed to the generation of the normal part 460 and/or the error part 461 (e.g., the artifact 430 in FIG. 4A) from an AI technique 450 (e.g., layer-wise relevance propagation, LRP) that may explain the identified error part (e.g., the artifact 430 in FIG. 4A). For example, ResNet classifier 450 may classify normal patterns and/or abnormal patterns for the output of the encoder 421, and may be pre-learned. For example, the ResNet classifier 450 may be used to apply LRP to the TTS model based on the encoder 421, the decoder 422, and/or the attention 423. The ResNet classifier 450 may be used to detect the abnormal pattern of the encoder 421, but this is exemplary and may be replaced with a classifier such as VGG-16, for example. By applying LRP to the encoder 421 for the abnormal pattern detected by the ResNet classifier 450, an encoder node having a relatively large contribution to the abnormal pattern may be identified, and modification for the corresponding encoder node may be performed.

According to an embodiment, the electronic device may consider a node having a high contribution to the artifact 461 as a factor causing an error, and may modify the node.

For example, the electronic device may reduce the contribution by removing the node having a high contribution by making the node 0, or by reducing weight values of the related node. For example, the electronic device may reduce the weight by half or less. The encoder 440 of the TTS model may be modified, based on the changed weight of the related node.

FIG. 4C is a diagram illustrating a voice signal in which an error part is modified through a modified TTS model of an electronic device according to an embodiment.

Referring to FIG. 4C, the electronic device may input the input text (e.g., the input text 410 in FIG. 4A) and/or a character string 470 similar to the input text to the TTS model including the modified encoder 440 to obtain the voice signal 480 having the error part modified.

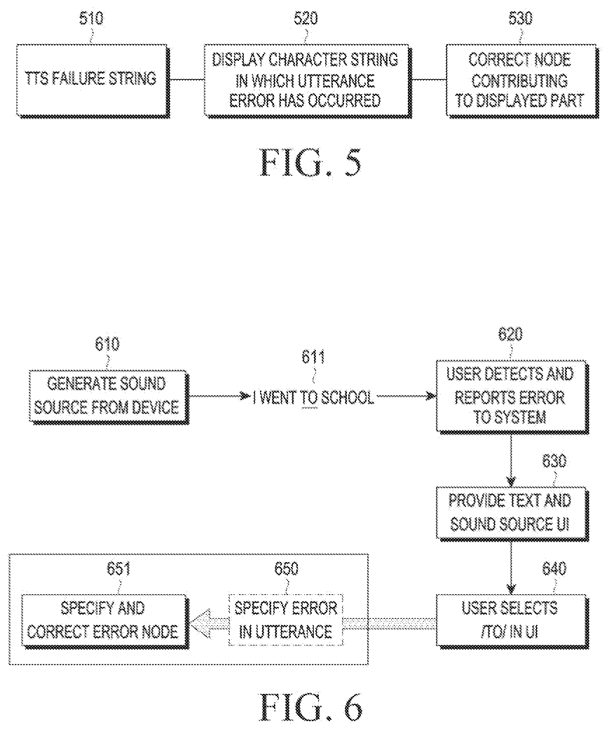

FIG. 5 is a diagram illustrating an operation of identifying an error part of a voice signal of an electronic device by a user input according to an embodiment.

Referring to FIG. 5, the electronic device (e.g., the electronic device 101 of FIG. 1 or the processor 120 of FIG. 1) may display a TTS failure string in operation 510. For example, when a user input indicating that there is an error in the voice signal output from a TTS model is received, the electronic device may display input text including the TTS failure string.

According to an embodiment, in operation 520, the electronic device may receive a user input displaying a character string in which an utterance error has occurred.

According to an embodiment, in operation 530, the electronic device may modify a node contributing to a part displayed by a user input.

For example, the electronic device may obtain contributions of a plurality of nodes included in the TTS model related to a character string selected by the user input, and modify at least one node having a contribution greater than or equal to a configured value.

In this way, when the character string in which an error is generated by a user is specified, accuracy of error correction may be improved.

FIG. 6 is a diagram illustrating an operation of modifying an error part by a user input of an electronic device according to an embodiment.

Referring to FIG. 6, an electronic device (e.g., the electronic device 101 of FIG. 1 or the processor 120 of FIG. 1) may generate a sound source in operation 610. For example, the generated sound source is output data of a TTS model and may be output through a speaker (e.g., the sound output module 155 of FIG. 1). For example, the voice signal output based on the TTS model may correspond to the input text/I went to school/611.

According to an embodiment, in operation 620, the electronic device may receive a user input reporting that an error has been detected.

According to an embodiment, in operation 630, the electronic device may provide the input text and/or the output waveform of the sound source as a user interface. For example, the electronic device may classify the waveform of a sound source for each pronunciation string and display a part of the waveform corresponding to the pronunciation string. For example, the electronic device may divide the waveform of the sound source into subdivisions (e.g., may be a word, syllable, or phrase, but is not limited to) of the input text and display a part of the waveform corresponding to the subdivisions together (or alone).

According to an embodiment, in operation 640, the electronic device may receive a user input for selecting an error part (e.g., /to/) through a user interface providing input text and/or the waveform of the sound source.

According to an embodiment, the electronic device may omit operation 650 of specifying an error in utterance, and may specify and modify an error node in operation 651. For example, when recognizing at least one phoneme part of the voice signal that is greater than or equal to the preset length, a waveform part outside the preset range, and/or a voice signal, the electronic device may omit the operation of identifying a part in which the recognized text and the input text are different, and identify a part selected by a user input as the error part.

According to an embodiment, the electronic device may obtain a contribution to the error part of each of a plurality of nodes included in the TTS model through an explainable AI technique, and identify at least one node having a contribution to the error part greater than or equal to a configured value.

According to an embodiment, the electronic device may modify and remove at least one node whose contribution to the error part is greater than or equal to 0, reduce the weight, or replace the algorithm with another reliable algorithm in relation to the pronunciation string of the error part.

In this way, when a character string in which an error is generated by a user is specified, accuracy of error correction may be improved.

FIG. 7 is a diagram illustrating an operation of updating a TTS model, based on error information collected from various users of an electronic device according to an embodiment.

Referring to FIG. 7, an electronic device (e.g., the electronic device 101 of FIG. 1 or the processor 120 of FIG. 1) may obtain error correction node information 710 of user A. According to an embodiment, the electronic device may obtain error correction node information 711 of user B. According to an embodiment, the electronic device may obtain error correction node information 712 of user C. According to an embodiment, the error correction node information 710, 711, and 712 may be obtained by different users in the same electronic device or obtained by different users in different electronic devices. According to an embodiment, the error correction node information 710, 711, and 712 may include the pronunciation string in which the error occurred, the sentence including the error, node information related to the error, modification information of the node, and/or used (e.g., prior to modification) TTS model version information.

According to an embodiment, the error correction node information 710, 711, and 712 obtained by different users may be collected by a server (e.g., the server 108 of FIG. 1) in operation 720.

According to an embodiment, the server may reflect the error correction node information 710, 711, and 712 to the TTS model 730 and perform an update after verification through operation 740. For example, the server may verify the modified TTS model 730 by inputting a pronunciation string similar to the pronunciation string in which the error occurred, by inputting a pronunciation string in which the error-occurred phoneme is changed to another phoneme, by inputting a sentence including the word in which the error occurred among several pre-stored sentences, or by inputting a sentence in which an error-occurred word is inserted into a sentence template pre-stored in the modified TTS model 730 based on the error correction node information 710, 711, and 712. According to an embodiment, when it is verified that no error is occurred by the modified TTS model 730, the server may update the TTS model 730.

According to an embodiment, the server may update the TTS model stored in each electronic device by transmitting information on the modified TTS model 730 to at least one electronic device corresponding to the user who provided the error correction node information 710, 711, and 712 and/or at least one electronic device corresponding to the user X 750 and the user Y 751 who did not report the error.

In this way, when problems encountered by each user are different, errors found by each user may be errors that other users who have not yet encountered the error may potentially encounter in the future. Therefore, if errors are regularly collected on the server, validated, and updated by putting the errors into one model, it is possible to obtain node information modified by other users. In this case, when the user operates the TTS model in the future, potential utterance error issues are removed in advance, so the satisfaction of use may be increased.

In addition, the update is applied in advance to users who have not reported errors, so that users who are not currently using but will use in the future may greatly reduce the probability of experiencing an utterance error.

FIG. 8 is a diagram illustrating an error report displayed on an electronic device according to an embodiment.

Referring to FIG. 8, when a synthesized speech 810 is generated through the TTS model, the electronic device (e.g., the electronic device 101 of FIG. 1 or processor 120 of FIG. 1) may display a first screen 820 for outputting the speech. According to an embodiment, the first screen 820 may include a UI 821 for playing the synthesized speech 810 or a UI 822 for reporting that an error is included in the synthesized speech 810.

According to an embodiment, when a user input for selecting the UI 822 for reporting that an error is included in the synthesized speech 810 is received, the electronic device may display a second screen 830 for specifying the error.

According to an embodiment, the second screen 830 may include a speech visualization UI 831 displaying the waveform of the synthesized speech 810, a UI 832 displaying input text corresponding to the synthesized speech 810, a UI 833 for selecting the type of error, and/or a UI 834 for submitting information related to an error.

According to an embodiment, the speech visualization UI 831 displaying the waveform of the synthesized speech 810 may classify and display the waveform of the synthesized speech 810 by pronunciation string, and each pronunciation string may be selected by a user input.

According to an embodiment, the UI 832 displaying input text corresponding to the synthesized speech 810 may display all of the input text, and each text may be selected by a user input.

According to an embodiment, the UI 833 for selecting the type of error may display the type of error, such as duplicate speech, noise, and/or different pronunciation, and type of each error may be selected by a user input.

According to an embodiment, when a user input for selecting the UI 834 for submitting information related to an error is received, the electronic device may display a third screen 840 for displaying a modification result.

According to an embodiment, before displaying the third screen 840, the electronic device may identify at least one node of the TTS model related to the error part and modify the at least one node, based on the error part specified by information specific to the error part included in the synthesized speech 810 and/or the user input received through the second screen 830, and modify at least one node.

According to an embodiment, the third screen 840 may include a UI 841 for reproducing the modified sound source, a UI 842 for providing information related to the modified section, a UI 843 for visualizing the reliability of the modified TTS model, and/or a UI 844 for reporting that an error is included in the modified sound source.

According to an embodiment, the UI 842 for providing information related to the modified section may display the modified part by the modified TTS model in text and/or waveform.

According to an embodiment, the UI 843 for visualizing the reliability of the modified TTS model may display a verification result obtained by verifying at least one similar character string similar to the input text in which the error occurred through the modified TTS model. For example, the UI 843 for visualizing the reliability of the modified TTS model may display the ratio of normally uttered sentences among 100 similar s character strings.

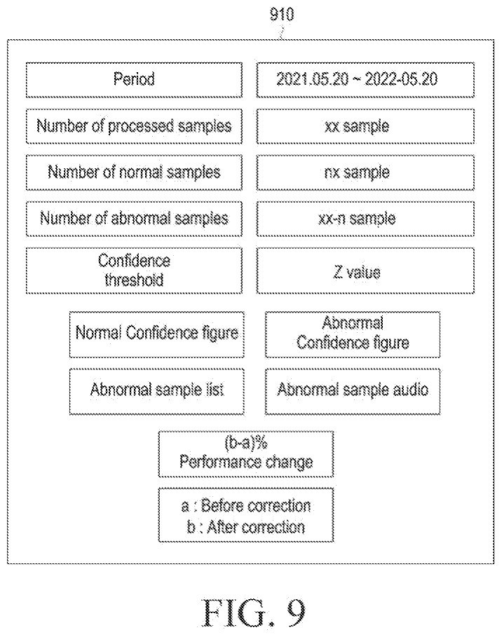

FIG. 9 is a diagram illustrating a user interface that may be viewed by an administrator of a TTS model according to an embodiment.

Referring to FIG. 9, an electronic device (e.g., the electronic device 101 of FIG. 1 or the processor 120 of FIG. 1) may provide a UI 910 related to a modification history of a TTS model to the administrator.

According to an embodiment, the UI 910 related to the modification history of the TTS model provided to the administrator may receive information on a detected error and a modification result from a server (e.g., the server 108 of FIG. 1).

According to an embodiment, the UI 910 related to the modification history of the TTS model provided to the administrator may include information on the modification period of the TTS model, the number of modified samples, the number of normally processed samples among the modified samples, the number of abnormally processed samples among modified samples, and/or a confidence threshold for classifying normal and abnormal. For example, the confidence threshold may be modified, and may be modified through the UI according to an example, but the modification method is not limited.

According to an embodiment, the UI 910 related to the modification history of the TTS model provided to the administrator may further include visualized information on normal and abnormal confidence (confidence figure) and a sample list. As a result, it is possible to identify normal and abnormal changes according to the confidence threshold for the processed samples.

According to an embodiment, the UI 910 related to the modification history of the TTS model provided to the administrator may include numerical information on performance changes before and after modification of the TTS model. As a result, it is possible to provide accuracy that changes due to the modification of the TTS model.

According to an embodiment, an electronic device may include a memory and at least one processor operatively connected to the memory.

According to an embodiment, the at least one processor may output a voice signal, based on a text to speech (TTS) model including a plurality of nodes stored in the memory.

According to an embodiment, the at least one processor may identify an error part included in the voice signal, based on identification that the voice signal includes an error.

According to an embodiment, the at least one processor may identify the activity of each of the plurality of nodes related to the error part.

According to an embodiment, the at least one processor may modify at least one node among the plurality of nodes, based on the activity of each of the plurality of nodes.

According to an embodiment, the at least one processor may reduce the weight related to the at least one node.

According to an embodiment, the at least one processor may replace the at least one node with at least one node pre-stored in relation to the text corresponding to the error part.

According to an embodiment, the at least one processor may identify a part corresponding to the at least one phoneme as the error part, based on the inclusion of at least one phoneme having a preset length or more among a plurality of phonemes included in the voice signal.

According to an embodiment, the at least one processor may identify the waveform part as the error part, based on inclusion of a waveform part having a value outside the preset range among the waveforms of the voice signal.

According to an embodiment, the memory may include an automatic speech recognition (ASR) model.

According to an embodiment, the at least one processor may obtain text which is a result of recognition of the voice signal, based on the ASR model.

According to an embodiment, the at least one processor may identify the other part as the error part, based on the inclusion of the text having a part different from the input text corresponding to the voice signal input to the TTS model.

According to an embodiment, the electronic device may further include a display.

According to an embodiment, the at least one processor may display input text corresponding to the voice signal input to the TTS model on the display.

According to an embodiment, the at least one processor may identify the error part of the voice signal, based on reception of a user input for selecting an error part of the input text through the display.

According to an embodiment, the at least one processor may identify the sentence structure of the input text corresponding to the voice signal input to the TTS model.

According to an embodiment, the at least one processor may obtain at least one character string, based on the sentence structure.

According to an embodiment, the at least one processor may input the at least one character string into the TTS model.

According to an embodiment, the at least one processor may determine whether the error part is modified, based on the voice signal for the at least one character string output based on the TTS model.

According to an embodiment, the at least one character string may be a text obtained by changing the text before and/or after the error part of the input text corresponding to the voice signal input to the TTS model.

According to an embodiment, the electronic device may further include a communication module.

According to an embodiment, the at least one processor may transmit information related to the error part and modification of the at least one node to a server.

According to an embodiment, the at least one processor may receive a modified TTS model from the server.

According to an embodiment, the at least one processor may update the TTS model stored in the memory, based on the modified TTS model.

According to an embodiment, a control method of an electronic device may include outputting a voice signal, based on a text to speech (TTS) model including a plurality of nodes stored in the memory.

According to an embodiment, a control method of an electronic device may include identifying an error part included in the voice signal, based on identification that the voice signal includes an error.

According to an embodiment, a control method of an electronic device may include identifying the activity of each of the plurality of nodes related to the error part.

According to an embodiment, a control method of an electronic device may include modifying at least one node among the plurality of nodes, based on the activity of each of the plurality of nodes.

According to an embodiment, the modifying at least one node may reduce the weight related to the at least one node.

According to an embodiment, the modifying at least one node may replace the at least one node with at least one node pre-stored in relation to the text corresponding to the error part.

According to an embodiment, the identifying an error part included in the voice signal may identify a part corresponding to the at least one phoneme as the error part, based on the inclusion of at least one phoneme having a preset length or more among a plurality of phonemes included in the voice signal.

According to an embodiment, the identifying an error part included in the voice signal may identify the waveform part as the error part, based on inclusion of a waveform part having a value outside the preset range among the waveforms of the voice signal.

According to an embodiment, the memory may include an automatic speech recognition (ASR) model.

According to an embodiment, the identifying an error part included in the voice signal may obtain text which is a result of recognition of the voice signal by using the ASR model.

According to an embodiment, the identifying an error part included in the voice signal may identify the other part as the error part, based on the inclusion of the text having a part different from the input text corresponding to the voice signal input to the TTS model.

According to an embodiment, the identifying an error part included in the voice signal may display input text corresponding to the voice signal input to the TTS model on the display.

According to an embodiment, the identifying an error part included in the voice signal may identify the error part of the voice signal, based on reception of a user input for selecting an error part of the input text through the display.

According to an embodiment, a control method of an electronic device may further include identifying the sentence structure of the input text corresponding to the voice signal input to the TTS model.

According to an embodiment, a control method of an electronic device may further include obtaining at least one character string, based on the sentence structure.

According to an embodiment, a control method of an electronic device may further include inputting the at least one character string into the TTS model.

According to an embodiment, a control method of an electronic device may further include determining whether the error part is modified, based on the voice signal for the at least one character string output based on the TTS model.

According to an embodiment, the at least one character string may be a text obtained by changing the text before and/or after the error part of the input text corresponding to the voice signal input to the TTS model.

According to an embodiment, a control method of an electronic device may further include transmitting information related to the error part and modification of the at least one node to a server.

According to an embodiment, a control method of an electronic device may further include receiving a modified TTS model from the server.

According to an embodiment, a control method of an electronic device may further include updating the TTS model stored in the memory, based on the modified TTS model.

According to an embodiment, in a non-transitory computer-readable recording medium that stores one or more programs, the one or more programs may include instructions for the electronic device to output a voice signal, based on a text to speech (TTS) model including a plurality of nodes stored in the memory.

According to an embodiment, the one or more programs may include instructions for the electronic device to identify an error part included in the voice signal, based on identification that the voice signal includes an error.

According to an embodiment, the one or more programs may include instructions for the electronic device to identify the activity of each of the plurality of nodes related to the error part.

According to an embodiment, the one or more programs may include instructions for the electronic device to modify at least one node among the plurality of nodes, based on the activity of each of the plurality of nodes.

According to an embodiment, the one or more programs may include instructions for the electronic device to reduce the weight related to the at least one node.

According to an embodiment, the one or more programs may include instructions for the electronic device to replace the at least one node with at least one node pre-stored in relation to the text corresponding to the error part.

According to an embodiment, the one or more programs may include instructions for the electronic device to identify a part corresponding to the at least one phoneme as the error part, based on the inclusion of at least one phoneme having a preset length or more among a plurality of phonemes included in the voice signal.

According to an embodiment, the one or more programs may include instructions for the electronic device to identify the waveform part as the error part, based on inclusion of a waveform part having a value outside the preset range among the waveforms of the voice signal.

According to an embodiment, the memory may include an automatic speech recognition (ASR) model.

According to an embodiment, the one or more programs may include instructions for the electronic device to obtain text which is a result of recognition of the voice signal, based on the ASR model.

According to an embodiment, the one or more programs may include instructions for the electronic device to identify the other part as the error part, based on the inclusion of the text having a part different from the input text corresponding to the voice signal input to the TTS model.

According to an embodiment, the electronic device may further include a display.

According to an embodiment, the one or more programs may include instructions for the electronic device to display input text corresponding to the voice signal input to the TTS model on the display.

According to an embodiment, the one or more programs may include instructions for the electronic device to identify the error part of the voice signal, based on reception of a user input for selecting an error part of the input text through the display.

According to an embodiment, the one or more programs may include instructions for the electronic device to identify the sentence structure of the input text corresponding to the voice signal input to the TTS model.

According to an embodiment, the one or more programs may include instructions for the electronic device to obtain at least one character string, based on the sentence structure.

According to an embodiment, the one or more programs may include instructions for the electronic device to input the at least one character string into the TTS model.

According to an embodiment, the one or more programs may include instructions for the electronic device to determine whether the error part is modified, based on the voice signal for the at least one character string output based on the TTS model.

According to an embodiment, the at least one character string may be a text obtained by changing the text before and/or after the error part of the input text corresponding to the voice signal input to the TTS model.

According to an embodiment, the electronic device may further include a communication module.

According to an embodiment, the one or more programs may include instructions for the electronic device to transmit information related to the error part and modification of the at least one node to a server.

According to an embodiment, the one or more programs may include instructions for the electronic device to receive a modified TTS model from the server.

According to an embodiment, the one or more programs may include instructions for the electronic device to update the TTS model stored in the memory, based on the modified TTS model.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that the embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of, the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a memory; and
at least one processor operatively connected with the memory,
wherein the memory stores instructions configured to, when executed by the at least one processor, cause the electronic device to:
obtain a voice signal based on a text to speech (TTS) model including a plurality of nodes, stored in the memory, wherein the voice signal corresponds to an input text,
based on identifying that the voice signal includes an error, identify an error part of the voice signal which includes the identified error,
identify an activity of each of the plurality of nodes related to the error part, and
modify at least one node among the plurality of nodes based on the identified activity of the at least one node.

2. The electronic device of claim 1, wherein the memory stores instructions configured to, when executed by the at least one processor, cause the electronic device to reduce a weight related to the at least one node.

3. The electronic device of claim 1, wherein the memory stores instructions configured to, when executed by the at least one processor, cause the electronic device to replace the at least one node with at least one pre-stored node,
wherein the at least one pre-stored node is stored in the memory and corresponds to text corresponding to the error part.

4. The electronic device of claim 1, wherein the memory stores instructions configured to, when executed by the at least one processor, cause the electronic device to:
based on identifying that the voice signal includes at least one phoneme having a length equal to or greater than a preset length, identify a part of the voice signal corresponding to the at least one phoneme as the error part.

5. The electronic device of claim 1, wherein the memory stores instructions configured to, when executed by the at least one processor, cause the electronic device to:
based identifying that the voice signal includes a waveform part having an abnormal waveform, identify the waveform part as the error part.

6. The electronic device of claim 1, wherein an automatic speech recognition (ASR) model is stored in the memory, and
wherein the memory stores instructions configured to, when executed by the at least one processor, cause the electronic device to:
obtain text which is a result of applying the ASR model to the voice signal, and
based on identifying that the text includes a part which is different from the input text, identify the part which is different from the input text as the error part.

7. The electronic device of claim 1, further comprising a display,
wherein the memory stores instructions configured to, when executed by the at least one processor, cause the electronic device to:
display the input text on the display, and
identify the error part based on a user input received through the display, wherein the user input comprises selection of a portion of the input text.

8. The electronic device of claim 1, wherein the memory stores instructions configured to, when executed by the at least one processor, cause the electronic device to:
identify a sentence structure of the input text,
obtain, based on the sentence structure, at least one character string,
obtain a character string voice signal resulting from inputting the at least one character string into the TTS model, and
identify, based on the character string voice signal, whether the error part has been modified.

9. The electronic device of claim 8, wherein the at least one character string is obtained by changing a text before or after a portion of the input text corresponding to the error part.

10. The electronic device of claim 1, further comprising a communication module, wherein the memory stores instructions configured to, when executed by the at least one processor, cause the electronic device to:
control the communication module to transmit to a server information related to the error part and the modification of the at least one node,
receive, through the communication module, a modified TTS model from the server, and
update the TTS model stored in the memory based on the modified TTS model.

11. A method of controlling an electronic device, the method comprising:
obtaining a voice signal based on a text to speech (TTS) model, including a plurality of nodes, stored in memory of the electronic device, wherein the voice signal corresponds to an input text;
based on identifying that the voice signal includes an error, identifying an error part of the voice signal which includes the identified error;
identifying an activity of each of the plurality of nodes related to the error part; and
modifying at least one node among the plurality of nodes based on the identified activity of the at least one node.

12. The method of claim 11, wherein the modifying the at least one node comprises reducing a weight related to the at least one node.

13. The method of claim 11, wherein the modifying the at least one node comprises replacing the at least one node with at least one pre-stored node corresponding to text corresponding to the error part.

14. The method of claim 11, wherein the identifying the error part comprises, based on identifying that the voice signal includes at least one phoneme having a length equal to or greater than a preset length, identifying a part of the voice signal corresponding to the at least one phoneme as the error part.

15. The method of claim 11, wherein the identifying the error part comprises, based on identifying that the voice signal includes a waveform part having a value outside a preset range, identifying the waveform part as the error part.

16. The method of claim 11, wherein an automatic speech recognition (ASR) model is stored in the memory, and
wherein the identifying the error part comprises:
obtaining text which is a result of applying the ASR model to the voice signal; and
based on identifying that the text includes a part which is different from the input text, identifying the part which is different from the input text as the error part.

17. The method of claim 11, wherein the identifying the error part comprises:
displaying the input text on a display of the electronic device; and
identifying the error part based on a user input received through the display, wherein the user input comprises selection of a portion of the input text.

18. The method of claim 11, further comprising:
identifying a sentence structure of the input text;
obtaining, based on the sentence structure, at least one character string;
obtaining a character string voice signal resulting from inputting the at least one character string into the TTS model; and
identifying, based on the character string voice signal, whether the error part has been modified,
wherein the obtaining at least one character string comprises changing a text before or after a portion of the input text corresponding to the error part.

19. The method of claim 11, further comprising:
transmitting to a server information related to the error part and the modification of the at least one node;
receiving a modified TTS model from the server; and
updating the TTS model stored in the memory based on the modified TTS model.

20. A non-transitory computer readable medium storing one or more programs, the one or more programs may comprise instructions that enable an electronic device to:
obtain a voice signal based on a text to speech (TTS) model, including a plurality of nodes, stored in memory of the electronic device, wherein the voice signal corresponds to an input text;
based on identifying that the voice signal includes an error, identify an error part of the voice signal which includes the identified error;
identify an activity of each of the plurality of nodes related to the error part; and
reduce a weight related to at least one node among the plurality of nodes based on the identified activity of the at least one node.
